(19) United States
(12) Patent Application Publication
(10) Pub. No.: US 2019/0196911 A1
(43) Pub. Date: Jun. 27, 2019

(54) COMPUTER SYSTEM

(71) Applicant: HITACHI, LTD., Tokyo (JP)

(72) Inventors: Ai SATOYAMA, Tokyo (JP); Tomohiro KAWAGUCHI, Tokyo (JP); Akira DEGUCHI, Tokyo (JP); Kazuei HIRONAKA, Tokyo (JP)

(73) Assignee: HITACHI, LTD., Tokyo (JP)

(21) Appl. No.: 16/326,788

(22) PCT Filed: Jan. 25, 2017
(86) PCT No.: PCT/JP2017/002595

§ 371 Date: Feb. 20, 2019

(51) Int. Cl. G06F 11/10; G06F 12/02; G06F 3/06

(52) U.S. Cl. CPC G06F 11/1092; G06F 11/1096; G06F 3/0689; G06F 3/0629; G06F 3/0619; G06F 12/0253

(57) ABSTRACT

A method for restoring lost data in a failed storage drive includes: detecting a trouble in a storage drive in a first RAID group of a first RAID type; in each of striped lines including host data which is lost due to a failure of the storage drive, restoring the host data, in the first RAID group; forming data of a striped line of a second RAID type from host data of a striped line of the first RAID group, the number of strips of the second RAID type being smaller than the number of strips of the first RAID type; configuring a second RAID group of the second RAID type by a storage drive included in the first RAID group excluding the failed storage drive; and storing data of a striped line of the second RAID type in the second RAID group.

### TECHNICAL FIELD

The present invention relates to restoration of lost data.

### BACKGROUND ART

In general, at a trouble of one drive, a system manager replaces the trouble drive with a spare drive. The system reads data of same striped lines from a plurality of drives other than the trouble drive, restores data stored in the trouble drive, and stores the restored data in the spare drive.

Using the spare drive and a plurality of drives other than the trouble drive, a RAID configuration is realized with the same RAID type, to realize the striped lines. Further, after completing changing from the trouble drive to a new drive, the system copies data inside the spare drive to the new drive, and generates the RAID configuration including the new drive in place of the spare drive.

When a trouble has occurred in the drive, the spare drive is used instead of the trouble drive only while the trouble drive is replaced by a new drive, and is not used for ordinary operations. Use of the spare drive is disclosed, for example, in U.S. Pat. No. 8,285,928.

### CITATION LIST

### Patent Literature

Patent Literature 1: U.S. Pat. No. 8,285,928

### SUMMARY OF INVENTION

### Technical Problem

To reduce the constituent elements and the cost of a storage device, there is a demand of eliminating the spare drive. The spare drive is a free region, which is not used for ordinary operations and is always reserved for when a trouble occurs. However, even in a configuration without any prepared spare drive, it is required to ensure reliability at the occurrence of a trouble in the drive.

### Solution to Problem

A typical example of the present invention is a computer system, comprising: a memory; and a processor which operates in accordance with a program stored in the memory, wherein the processor detects a failure of a storage drive in a first RAID group of a first RAID type, in each of striped lines including lost host data due to a failure of the storage drive, restores the host data, in the first RAID group, forms data of a striped line of a second RAID type from host data of a striped line in the first RAID group, number of strips of the second RAID type being smaller than number of strips of the first RAID type, configures a second RAID group of the second RAID type by the storage drive included in the first RAID group excluding the failed storage drive, and stores the data of the striped line of the second RAID type in the second RAID group.

### Advantageous Effects of Invention

According to an aspect of the present invention, it is possible to ensure reliability at the occurrence of a trouble in the drive, in the configuration without any prepared spare drive.

### BRIEF DESCRIPTIONS OF DRAWINGS

FIG. 1 illustrates a flowchart of a rebuilding method.

FIG. 2 illustrates a configuration example of a system.

FIG. 3 illustrates a configuration example of a flash package.

FIG. 4 illustrates the relationship between pages of a virtual volume, pages of a pool, blocks of a flash-side pool, and blocks of a flash package.

FIG. 5 illustrates management information stored in a shared memory of a storage device.

FIG. 6 illustrates a format example of information regarding one virtual volume (TPVOL) represented in virtual volume information.

FIG. 7 illustrates a format example of pool information.

FIG. 8 illustrates a format example of page information.

FIG. 9 illustrates an example of a free page management pointer in a page of a pool.

FIG. 10 illustrates a format example of parity group information.

FIG. 11 illustrates a format example of flash package information.

FIG. 12 illustrates an example of a rebuilding process of striped lines.

FIG. 13A illustrates a restoration example of host data.

FIG. 13B illustrates a restoration example of host data.

FIG. 14A illustrates a data status in a parity group during rebuilding.

FIG. 14B illustrates a data status in a parity group during rebuilding.

FIG. 15 illustrates a process in a case where a write command is received, during rebuilding of RAID.

FIG. 16 illustrates a state transition diagram in a striped line rebuilding.

FIG. 17A illustrates an example of a free region in a parity group.

FIG. 17B illustrates an example of a free region in a parity group.

FIG. 17C illustrates an example of a free region in a parity group.

FIG. 17D illustrates an example of a free region in a parity group.

FIG. 18 illustrates a flowchart of a free capacity monitoring process.

FIG. 19A illustrates an example of a state transition of a parity group in a 14D+2P (RAID 6) configuration.

FIG. 19B illustrates an example of a state transition of a parity group in a 14D+2P (RAID 6) configuration.

### DESCRIPTION OF EMBODIMENT

A preferred embodiment will be described by reference to the drawings. This embodiment is only one example for realizing the invention, and is not to limit the technical range of the invention. The common configuration in the drawings is denoted by the same reference numeral.

In the following descriptions, information in the present invention will be described with an expression of “table”. Those information items may not necessarily be expressed in a data structure with a table, and may be expressed in a data structure, such as “list”, “DB (database)”, “queue”, or any other form. Thus, to represent that it does not depend on the data structure, the “table”, the “list”, the “DB”, and the “queue” may be referred to simply as “information”. When to describe the contents of each information item, expressions like “identifier information”, “identifier”, “name”, “label”, and “ID” can be used. These expressions can be replaced with each other.

In the following descriptions, the descriptions will be made with using a “program” as the subject. Because the program is executed by a processor to perform a determined process using a memory and a communication port (a communication control unit), the descriptions may be made with using the processor as the subject, or may be made with the controller as the subject.

The process disclosed with using the program as the subject may be a process performed by a computer or an information processing unit, such as a management server (management unit). A part or the entire of the program may be realized by the dedicated hardware, or may be modularized. Various programs may be installed in each computer by a program distribution server or a storage medium.

### (1) Summary

There will hereinafter be disclosed a rebuilding technique at the time of a trouble in the drive without the need of a spare drive. By the present technique, the system on which the spare drive is not mounted can continue operating, even when a trouble has occurred in a storage drive.

When a trouble has occurred in the disk with a configuration without the spare drive, the system rebuilds a RAID (Redundant Arrays of Independent Disks) group from nD+mP to (n−k)D+mP. In this case, n, m, and k are natural numbers. The system rebuilds, for example, from a RAID group of 7D+1P to a RAID group of 6D+1P. As a result, lost data can be restored without using the spare drive, and the reliability after rebuilding can be secured.

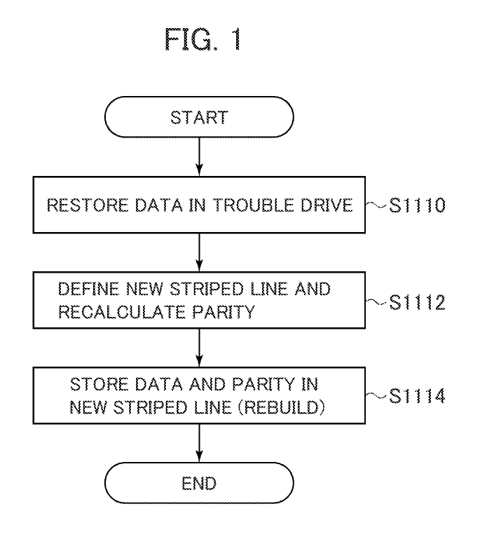

FIG. 1 illustrates a flowchart of a rebuilding method of this disclosure. When a trouble occurs in one storage drive, the system restores data stored in the trouble drive, using the data and the parity stored in any drive other than the trouble drive of the same RAID (S1110).

The system rebuilds a RAID group of a RAID type with a small number of configurations, defines new striped lines, and recalculates the parity of the striped lines (S1112). The system stores data and parity of new striped lines in the storage drive other than the trouble drive (S1114).

Descriptions will hereinafter be made to all-flash storage unit, as an example of the system configuration. However, as an HDD (Hard Disk Drive), any storage drive including any kind of storage medium is applicable.

### (2) System Configuration

### (a) System Hardware Configuration

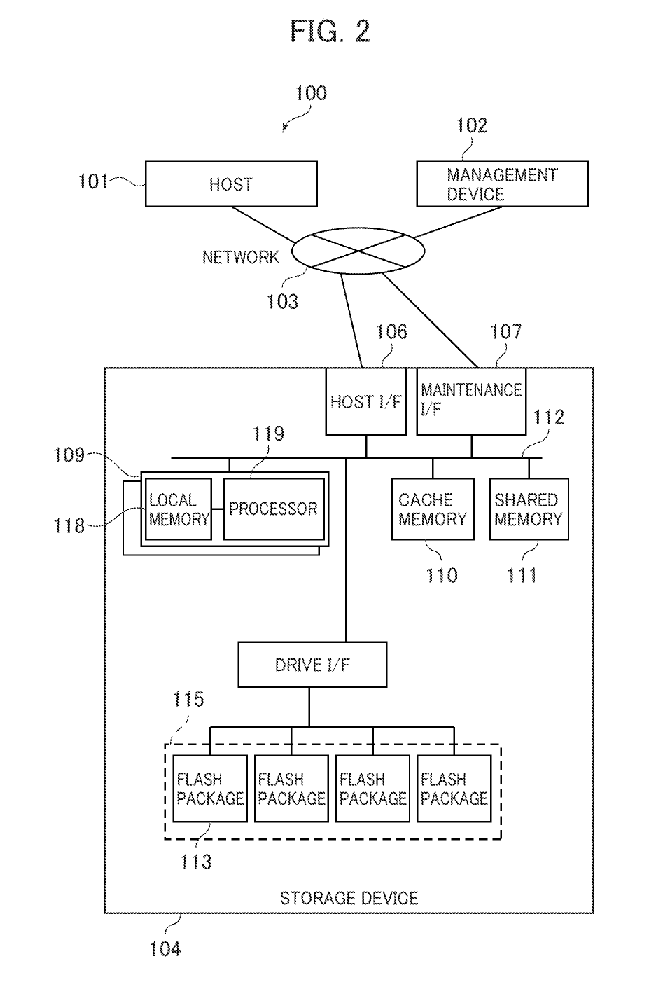

FIG. 2 illustrates a configuration example of a system 100 of this embodiment. The system 100 includes a host computer (host) 101, a management device 102, and a storage device 104. The host 101, the management device 102, and the storage device 104 are connected with each other through a network 103.

The network 103 is a SAN (Storage Area Network) which is formed using a fiber channel, as an example. The network 103 can use an I/O protocol for the mainframe, other than a protocol capable of transferring a SCSI command. The management device 102 may be connected to another device through a management network other than the network 103. The management device 102 may be excluded therefrom.

As illustrated in FIG. 2, the host 101 is a computer which executes an application program, and accesses a logical storage region of the storage device 104 through the network 103. The storage device 104 stores data in a storage region of a flash package 113. The number of hosts 101 differs between systems.

The host 101 includes, for example, an input device, an output device, a CPU (Central Processing Unit), a memory, a disk adaptor, a network adaptor, and a storage device. The CPU of the host 101 executes an application program used by the user and a storage device control program for performing the interface control with the storage device 104.

The host 101 uses a virtual volume provided by the storage device 104. The host 101 issues a read command or a write command as an access command, for the virtual volume, thereby accessing data stored in the virtual volume.

The management device 102 is a computer for managing the storage device 104 and configuring the storage region of, for example, the storage device 104, and includes a processor and a memory like the general computer. The management device 102 executes a management program for managing the storage device 104. The management device 102 includes an input/output device, such as a keyboard or a display, a CPU, a memory, a network adaptor, and a storage device, and outputs (displays) information about the state of the storage device 104 to the display.

The storage device 104 is an example of a computer system, and provides one or more volumes (virtual volume or logical volume) to the host 101. The storage device 104 includes a host interface (I/F) 106, a maintenance I/F 107, storage controllers 109, a cache memory 110, a shared memory 111, and a flash package 113. Let it be assumed that the hardware configuration is redundant.

These constituent elements are mutually connected through a bus 112. Of the constituent elements, a group of the host I/F 106, the maintenance I/F 107, the storage controllers 109, the cache memory 110, the shared memory 111, and the bus 112 may be referred to as a storage controller. The flash package 113 may be connected to another device through an external network. A configuration excluding the flash package 113 from the storage device 104 is also a computer system.

The host I/F 106 is an interface device for the storage device 104 to communicate with the initiator, such as the host 101. The command issued by the host 101 to access the volume (virtual volume in the following example) arrives at the host I/F 106. The storage device 104 returns information (response) from the host I/F 106 to the host 101.

The maintenance I/F 107 is an interface device for the storage device 104 to communicate with the management device 102. The command from the management device 102 arrives at the maintenance I/F 107. The storage device 104 returns information (response) from the maintenance I/F 107 to the management device 102.

In the example of FIG. 2, both of the host I/F 106 and the maintenance I/F 107 are connected to the network 103. The network connected to the host I/F 106 and the network connected to the maintenance I/F 107 may be differ from each other.

The cache memory 110 is configured with, for example, a RAM (Random Access Memory), and temporarily stores data read from and written into the flash package 113. The shared memory 111 stores programs operating on the storage controller 109 and configuration information.

The storage controller 109 is a package board having a processor 119 and a local memory 118. The processor 119 executes a program for performing various controls for the storage device 104. The local memory 118 temporarily stores the program executed by the processor 119 and information used by the processor 119.

FIG. 2 illustrates a configuration in which the storage device 104 has two storage controllers 109, but the number of storage controllers 109 may be any value other than two. Only one storage controller 109 may be mounted on the storage device 104, or three or more storage controllers 109 may be mounted thereon.

The cache memory 110 is used for temporarily storing write data for the virtual volume (flash package 113) or data (read data) read from the virtual volume (flash package 113). The cache memory 110 may be formed with a volatile memory, such as a DRAM or an SRAM, or a non-volatile memory.

The shared memory 111 provides a storage region for storing management information used by the storage controller 109 (its processor 119). Like the cache memory 110, the shared memory 111 may be formed with a volatile memory, such as a DRAM or an SRAM, or a non-volatile memory. Unlike the local memory 118, the cache memory 110 and the shared memory 111 can be accessed from the processor 119 of an arbitrary storage controller 109.

The flash package 113 is a storage drive (storage device) including a non-volatile storage medium for finally storing write data from the host 101. The storage controller 109 is to have a RAID function for restoring data of one flash package 113, even if this flash package 113 fails.

A plurality of flash packages 113 form one RAID group. This is called a parity group 115. The flash package 113 has a flash memory as a storage medium. One example of the flash package is an SSD (Solid State Drive).

The flash package 113 may have a function (compression function) for compressing write data and storing it in its storage medium. The flash package 113 provides one or more logical storage regions (logical volume) based on the RAID group. The logical volume is associated with a physical storage region included in the flash package 113 of the RAID group.

### (b) Flash Package

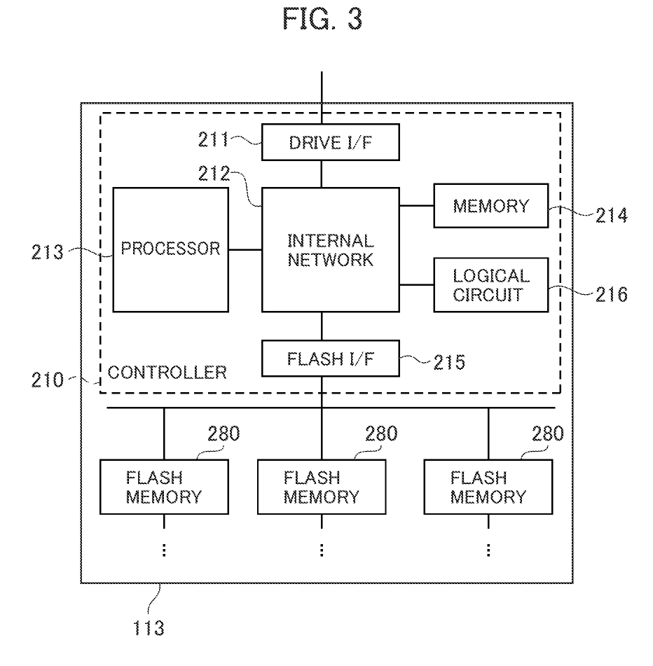

FIG. 3 illustrates a configuration example of the flash package 113. The flash package 113 has a controller 210 and a flash memory 280 as a storage medium for storing write data from the host 101. The controller 210 includes a drive I/F 211, a processor 213, a memory 214, a flash I/F 215, and a logical circuit 216 having a compression function, which are connected to each other through an internal network 212. The compression function may be excluded therefrom.

The drive I/F 211 is an interface device for communication with the storage device 104. The flash I/F 215 is an interface device for the controller 210 to communicate with the flash memory 280.

The processor 213 executes a program for controlling the flash package 113. The memory 214 stores a program executed by the processor 213 and control information used by the processor 213. A process (a process for managing the storage region and for an access request from the storage device 104) performed by the flash package 113 as will be described later is performed by the processor 213 executing the program. The processor 213 receives a read request or a write request from the storage controller 109, and executes a process in accordance with the received request.

At the stage when the processor 213 receives a write request from the storage controller 109, and when it writes data corresponding to the write request to the flash memory 280, it completes the write request (it reports completion of the write request to the storage controller 109). Alternatively, data to be read or written between the storage controller 109 and the flash memory 280 may temporarily be stored in a buffer (not illustrated). At the stage when the processor 213 writes data corresponding to the write request from the storage controller 109 into the buffer, it may transmit a completion report to the storage controller 109.

### (3) Relationship of Page and Block

In this embodiment, the storage device 104 has a capacity virtualization function. The control unit of the capacity virtualization is called a page. In this embodiment, the size of the page is greater than that of the block as an erasure unit in the flash memory. For example, the size of the page is an X times (X is an integer equal to or greater than 2) the size of the block. In this embodiment, the unit of the read and write in the flash memory is called a “segment”.

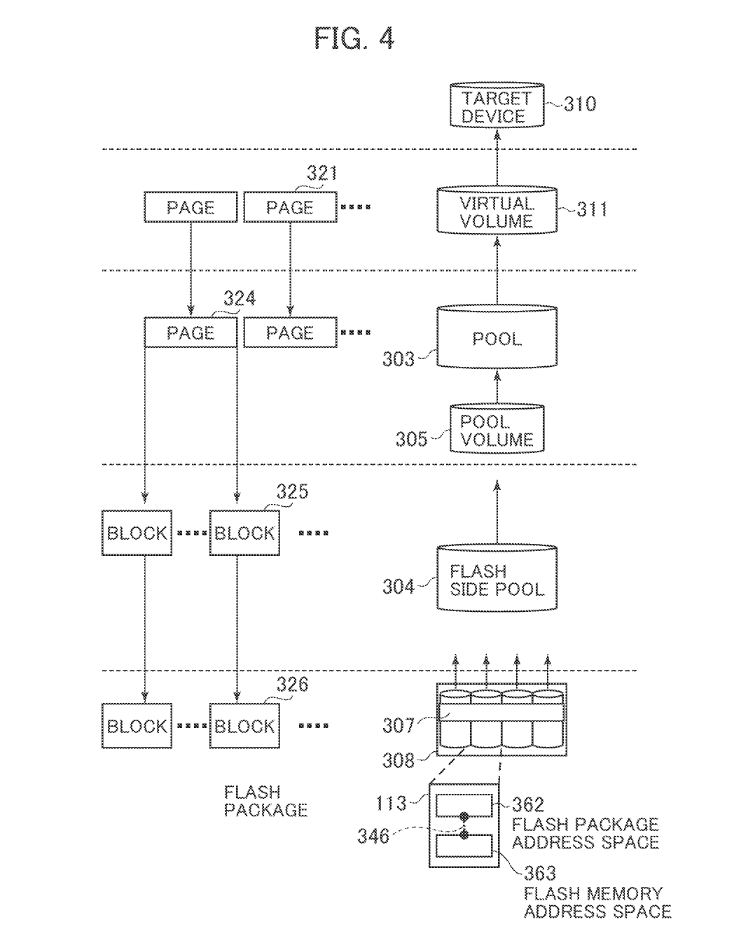

FIG. 4 illustrates the relationship between pages 321 of the virtual volume 311, pages 324 of the pool, blocks 325 of a flash-side pool 303, and blocks 326 of the flash package. The pages 324 of the pool 303 may store redundant data not included in the pages 321 of the virtual volume 311.

A target device 310 is a storage region permitting access from the host 101, of the virtual volume or the logical volume. The pages 321 are to form the virtual volume 311. The virtual volume 311 is a virtual storage region, which is defined using the pool 303 and adopts thin provisioning or/and tearing. The pool 303 is a group of pool volumes 305 for use in thin provisioning or tearing.

A pool volume 305 belongs to one pool 303. The pages 324 are cutout from the pool volume 305 (pool 303). The pages 324 are assigned to the pages 321 of the virtual volume. The pages 324 are assigned a real storage region of the parity group (RAID group) 115, through a flash-side pool 304. The parity group is defined a plurality of flash packages (storage drives) 113. This attains high reliability, a speed-up operation, and a large capacity by the RAID.

In this embodiment, the management unit of the capacity of the flash package 113 is the block as an erasure unit of the flash memory. The storage controller 109 accesses the flash package 113 in the unit of blocks. The blocks 325 of the flash-side pool 304 are virtual blocks seen from the storage controller 109. The blocks 326 are real blocks for actually storing data.

The flash-side pool 304 is formed from the virtual blocks 325. The pages 324 of the pool 303 correspond to the plurality of virtual blocks 325. Data stored in the virtual blocks 325 are stored in the real blocks 326 inside the flash package 113. The above storage method is one example.

The virtual blocks 325 of the flash-side pool 304 are mapped into the real blocks 326 through the blocks of a flash package address space 362. The flash package address space 362 is an address space of the flash package which can be seen from the storage controller 109.

In one flash package 113, the capacity configured with the virtual blocks of the flash package address space 362 may be greater than the capacity configured with the real blocks 326. The real blocks 326 are blocks of a flash memory address space 363. The flash packages 113 can be shown to the storage controller 109 as if they have a larger number of virtual blocks than the number of real blocks. The capacity configured with the virtual blocks is greater than the capacity configured with the real blocks.

When the flash package 113 receives a write request specifying an address which belongs to the virtual blocks 325 without the real blocks 326 assigned thereto, from the storage controller 109, it assigns the real block 326 to the virtual block 325.

As described above, the parity group 308 is configured with the flash packages 113 of a plurality of same kind of communication interfaces, and the striped lines (storage region) 307 across the plurality of flash packages 113 are defined. The striped lines store host data and parity data having a redundant configuration enabling to restore lost data.

The flash memory address space 363 is defined for flash memories 280 in the flash package 113. Further, for mapping between the flash memory address space 363 and the flash-side pool 304, the flash package address space 362 is defined. For each of the flash packages 113, the flash address space 363 and the flash package address space 362 are defined.

The flash-side pool 304 exists above the parity group 308. The flash-side pool 304 is a virtual storage source based on the parity group 308. For the flash-side pool 304, the flash-side pool address space 352 is defined. This address space 352 is an address space for mapping between an address space for managing the storage capacity on the side of the storage controller 109 and an address space for managing the storage capacity in the flash package.

If the mapping between the flash package address space 362 and the flash-side pool address space 352 is once determined, it is maintained (static). The mapping between the flash-side pool address space 352 and the pool address space 351 is also static.

The pool 303 on the side of the storage controller 109 is formed by the plurality of pool volumes 305. Because the pool volume 305 is an offline volume, they are not associated with a target device specified by the host 101. The pool volumes 305 are formed from a plurality of pages 324.

Blocks constituting the page 324 are mapped in one-to-one correspondence with the blocks 325 of the flash-side pool 304 (space 353). The blocks 325 are associated with the storage region of the striped line 307. Data stored in a block of the page 324 is stored in the striped line 307 associated with the block. A plurality of striped lines 307 may be associated with one page 324.

In the virtual page 321 of a virtual volume 311 (TPVOL: Thin Provisioning Volume) 311 in which the capacity is virtualized, a free page in the pool 303 associated with the TPVOL 311 for mapping is mapped. The storage controller 109 maps the free page in the assigned pool 303 into blocks of the flash-side pool address space 352, in the unit of blocks, and manages the mapping. That is, the blocks are in the unit of I/O from the storage controller 109.

The storage controller 109 searches for a block of the flash-side pool address space 362 into which the block of the flash-side pool address space 352 is mapped, and issues a read/write request to the side of the flash package. The mapping may be done in the unit of segments.

The target device 310 is defined above the TPVOL 311. One or more target devices 310 are associated with the communication port of the host 101, and the TPVOL 311 is associated with the target device 310.

The host 101 transmits an I/O command (a write command or a read command) specifying the target device 310 to the storage device 104. As described above, the TPVOL 311 is associated with the target device 310. When the storage device 104 receives a write command specifying the target device 310 associated with the TPVOL 311, it selects a free page 324 from the pool 303, and assigns it to the write destination virtual page 321.

The storage device 104 writes write data to the write destination page 324. Writing of data to the page 324 includes writing of data to the striped line 307 associated with the blocks 325 in the flash-side pool address space which are mapped to the page 324. That is, it includes writing of data to the flash memory associated with the striped line 307.

As described above, by having the same unit of data to be managed, the pool 303 and the flash-side pool 304 can be managed by setting one pool.

### (4) Management Information

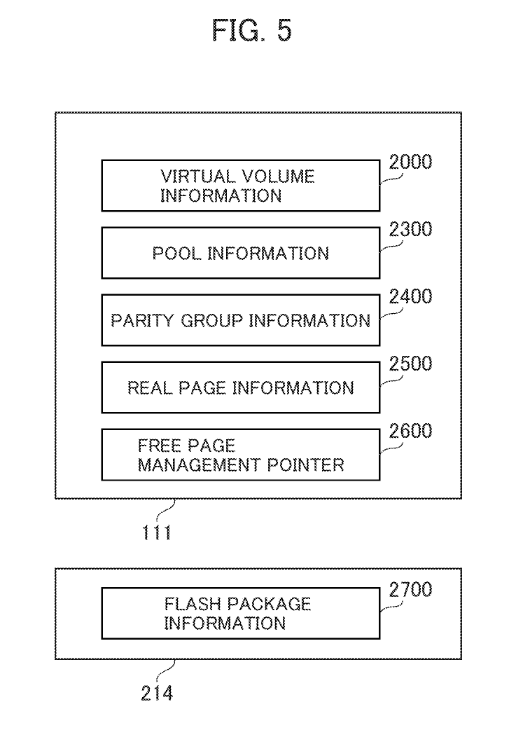

FIG. 5 illustrates management information stored in the shared memory 111 of the storage device 104. Virtual volume information 2000, pool information 2300, parity group information 2400, real page information 2500, and a free page management pointer 2600 are stored in the shared memory 111. The free page management pointer (information) 2600 manages free pages in association with each parity group 115.

Flash package information 2700 is stored in the memory 214 of the flash package 113. In this embodiment, the storage controller 109 has a capacity virtualization function. The storage controller 109 may not have the capacity virtualization function.

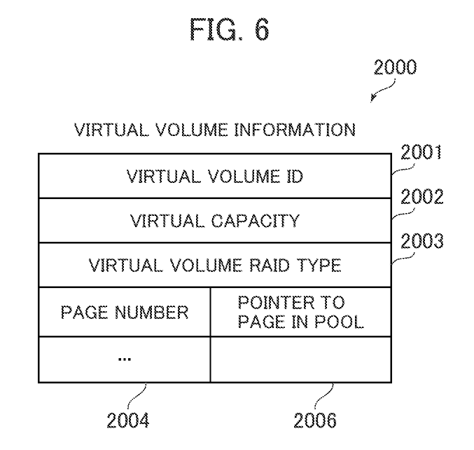

FIG. 6 illustrates a format example of information of one virtual volume (TPVOL) represented in the virtual volume information 2000. The virtual volume information 2000 maintains information of a plurality of virtual volumes in the device. The virtual volume is a virtual storage device from or to which the host 101 reads or writes data. The host 101 specifies an ID of the virtual volume, an address in the virtual volume, and the length of target data, and issues a read command or a write command.

The virtual volume information 2000 represents a virtual volume ID 2001, a virtual capacity 2002, a virtual volume RAID type 2003, a page number 2004 of the virtual volume, and a pointer 2006 to the page in the pool.

The virtual volume ID 2001 represents an ID of a corresponding virtual volume. The virtual capacity 2002 represents the capacity of the virtual volume seen from the host 101. The virtual volume RAID type 2003 represents the RAID type of the virtual volume. Like the RAID 5, when redundant data for one flash package 113 is stored in an N-number of flash packages 113, a specific number of N is specified.

The page number 2004 of the virtual volume represents the number of the virtual volume. The number of page numbers of the page numbers 2004 of the virtual volume is the page number of the virtual volume. The number of pages is a value which is obtained by dividing the value represented by the virtual capacity 2002 by a value represented by the virtual page capacity (described later).

The pointer 2006 to the page in the pool represents a pointer to the page information 2500 of a pool page assigned to the page of the virtual volume. Because the storage device 104 supports the virtual capacity function, the trigger to be assigned a page is actual data writing to the page of the virtual volume. The value of the pointer 2006 to the page in the pool is NULL. This pool corresponds to the virtual page without the writing being performed yet.

In this embodiment, the capacity of the page of the virtual volume is not always equal to the capacity of the page of the pool. This is because the page of the pool may store different redundant data in accordance with the type of the RAID. The page capacity of the pool is determined in accordance with the type of the RAID of the parity group 115 to which the page is assigned.

For example, like a RAID 1, when data is doubly written, the capacity of the page in the pool is twice the virtual page capacity. Like the RAID 5, for the capacity of an N-number of storage devices, when redundant data of the capacity of one storage device is stored, an (N+1)/N capacity of the virtual page capacity is the capacity of the page. Data, which is formed from one or a plurality of parity (redundant data) blocks and one or a plurality of (host) data blocks generating the blocks, is called a striped line. Data blocks of the striped line are also called a strip.

Like a RAID 0, when parity data is not used, the capacity of the page in the virtual volume is equal to the capacity of the page in the pool. In this embodiment, the capacity of the virtual page is common in one or a plurality of virtual volumes provided by the storage device 104. However, pages with different capacities may be included in the one or plurality of virtual volumes.

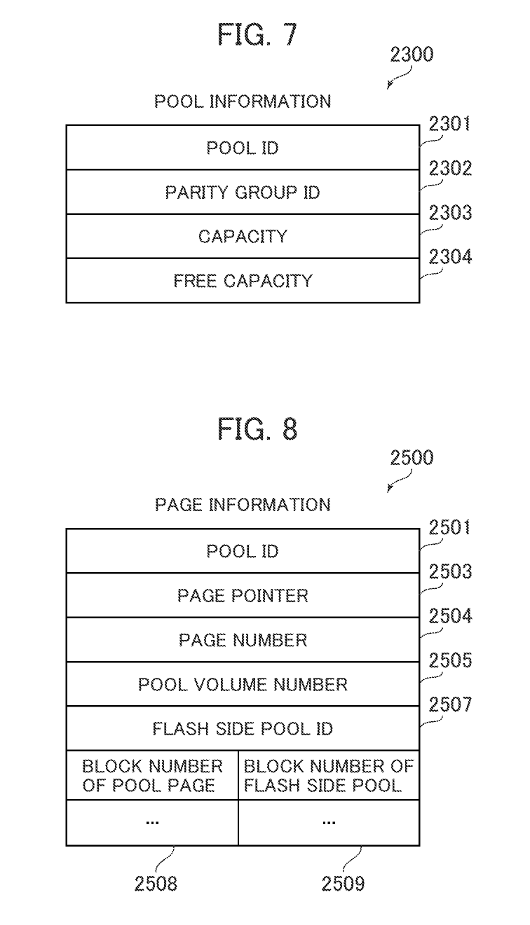

FIG. 7 illustrates a format example of pool information 2300. The pool information 2300 can include a plurality of pool information items. However, FIG. 7 illustrates one pool information item. The pool information 2300 includes a pool ID 2301, a parity group ID 2302, a capacity 2303, and a free capacity 2304.

The pool ID 2301 represents an ID of a pool. The parity group ID 2302 represents a parity group 115 for forming a pool. The capacity 2303 represents a storage capacity of the pool. The free capacity 2304 represents an available storage capacity in the pool.

FIG. 8 illustrates a format example of page information 2500. The page information 2500 is management information of a plurality of pages in the pool. However, FIG. 8 illustrates page information of one page. The page information 2500 includes a pool ID 2501, a page pointer 2503, a page number 2504, a pool volume number 2505, a page number 2506, a flash-side pool ID 2507, a block number 2508 of a pool page, and a flash-side pool block number 2509.

The pool ID 2501 represents an ID of a pool to which this page belongs. The page pointer 2503 is used at the time of performing queue management of a free page in this pool. The pool volume number 2505 represents a pool volume including this page. The page number 2504 represents the number in the pool volume of this page.

The flash-side pool ID 2507 represents a flash-side pool 304 having a flash-side address space 352 associated with the pool represented by the pool ID 2501. When the number of pool 303 and the number of the flash-side pool 304 are both one, this information is omitted.

The block number 2508 of the page represents the block number in the page in the pool address space. The flash-side pool block number 2509 represents a block number of the flash-side pool address space associated with the block number of the page.

The associating or assigning is performed at initialization setting of the storage device 104. The page information 2500 of the pool volume which is added during system operation is generated when this pool volume is added.

For mapping between the page of the pool address space and the page of the flash package address space, the page information 2500 may manage the page number of the flash package address space. The access unit for the flash memory is usually smaller than that of the page size. Thus, in this embodiment, the mapping is managed in the block unit. The mapping in the segment unit can be managed with the same method.

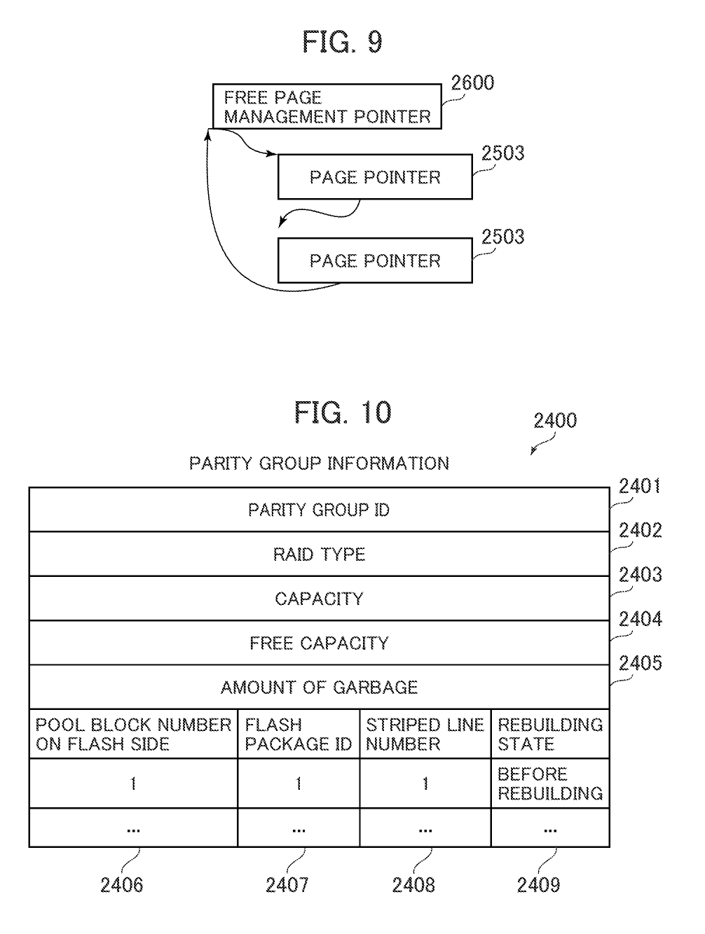

FIG. 9 illustrates an example of the free page management pointer 2600 of a page in the pool 303. More than one free page management pointer 2600 is provided for one pool. For example, the free page management pointer 2600 may be provided in association with each pool volume.

The free page and unavailable page are managed by queue. FIG. 9 illustrates a group of free pages managed by the free page management pointer 2600. The free page represents a page not assigned to the virtual page. The page information 2500 corresponding to the free page is called free page information. The free page management pointer 2600 indicates an address of the head free page information 2500. Next, the page pointer 2503 indicating the free page in the head page information 2500 indicates the next free page information 2500.

In FIG. 9, the free page pointer 2503 of the last free page information 2500 indicates the free page management pointer 2600, but may be “NULL”. When the storage controller 109 receives a write request for a virtual page without being assigned any page, it searches for any of the parity group 115 of the same type as the virtual volume RAID type 2003 of the virtual volume, from the free page management pointer 2600. The storage controller 109 assigns a free page of the parity group 115 having the largest number of free pages to the virtual page.

After the storage controller 109 assigns the free page to the page of the virtual volume, it updates the page pointer 2503 of a free page just before the assigned page. Specifically, the storage controller 109 changes the page pointer 2503 of page information 2500 of the previous free page, into the page pointer 2503 of the assigned page. Further, the storage controller 109 further subtracts the capacity of the assigned page from a value of the free capacity 2304 of corresponding pool information 2300, to update the value of the free capacity 2304.

FIG. 10 illustrates a format example of parity group information 2400. The parity group information 2400 is to manage mapping between the flash-side pool address space and the flash package address space. The parity group information can include information of a plurality of parity groups 115. However, FIG. 10 illustrates information of one parity group 115.

The parity group information 2400 represents a parity group ID 2401, a RAID type 2402, a capacity 2403, a free capacity 2404, and an amount of garbage 2405, a flash-side pool block number 2406, a flash package ID 2407, a striped line number 2408 (or a block number of a flash package address space), and a rebuilding state 2409.

The parity group ID 2401 represents an identifier of the corresponding parity group 115. The RAID type 2402 represents a RAID type of the corresponding parity group 115. The capacity 2403 represents the capacity of the parity group. The free capacity 2404 is a value obtained by subtracting the amount of garbage 2405 from the capacity 2403 of the parity group. The free capacity 2304 of the pool is a sum of the free capacities 2404.

The amount of garbage 2405 represents the capacity in which new data cannot be stored, because old data has been stored in the capacity 2403 of the parity group. The garbage exists in a draw type storage medium like the flash memory, and can be used as a free space by an erasure process.

The flash-side pool block number 2406 represents the number of a block as a management unit of the address space of the parity group. The flash-side pool block number 2406 represents the number of the block corresponding to a striped line. The flash package ID 2407 represents an ID of a flash package storing the block. As will be described later, when the block is temporarily stored in rebuilding of the striped line, the flash package ID 2407 represents a buffer address of a storage destination.

The striped line number 2408 represents the striped line in the parity group, corresponding to the block of the flash package address space. In this embodiment, one block corresponds to one strip. A plurality of blocks may correspond to one strip.

The rebuilding state 2409 represents a state of a rebuilding process for a new striped line to which each block corresponds. In this embodiment, a new striped line corresponding to the block is a new striped line from which data of the corresponding block is read from the flash package 113 for rebuilding (generation).

The rebuilding state 2409 represents a state (rebuilt) in which the rebuilding process for a new striped line has been completed, a state (rebuilding) in which the rebuilding process is being performed, and a state (before rebuilding) in which the rebuilding process has not yet been performed.

As will be described later, for rebuilding of a new striped line, the old striped line before rebuilding is read from the parity group (flash package), lost host data is restored. Further, a new striped line is generated from a part of the host data of the old striped line and, if necessary, data in the buffer.

The new striped line is overwritten in a storage region of the new parity group. Host data not included in the new striped line and included in the next new striped line is temporarily stored in the buffer.

In this embodiment, by the rebuilding of the striped line, the number of strips forming the striped line is reduced. The flash package and the striped line storing the block can be changed. The storage controller 109 updates the parity group information 2400 in accordance with the rebuilding process of each striped line.

If the rebuilding of one striped line (generation of a new striped line) is completed, the storage controller 109 updates the flash package ID 2407, the striped line number 2408, and the rebuilding state 2409, of a corresponding block.

The storage controller 109 overwrites the flash package ID 2407 and a value of the striped line number 2408, with information of the restored new striped line. When data of the block is temporarily stored in a buffer, the flash package ID 2407 represents this buffer, while the striped line number 2408 represents a NULL value.

If rebuilding of all striped line is completed, the storage controller 109 updates non-updated information (RAID type 2402 and capacity 2403) in the parity group information 2400, to decide the RAID configuration after rebuilding.

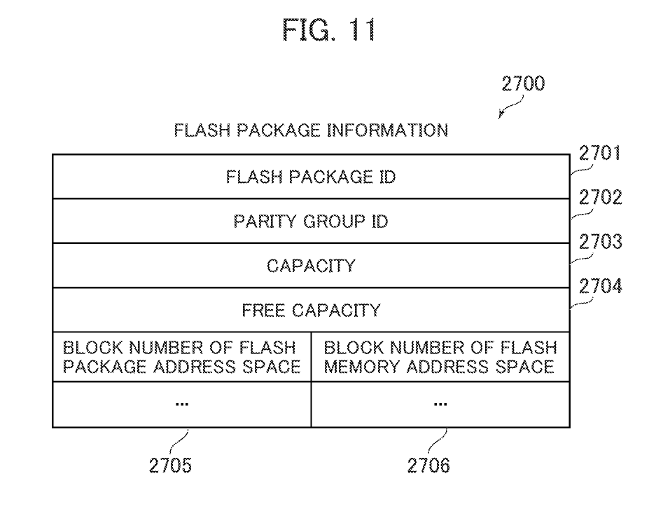

FIG. 11 illustrates a format example of the flash package information 2700. The flash package information 2700 is to manage mapping between the flash package address space and the address space of the flash memory. The flash package information 2700 is managed in each flash package, and stored in the memory 214. It is not accessed from the storage controller 109.

The flash package information 2700 represents a flash package ID 2701, a parity group ID 2702, a capacity 2703, a free capacity 2704, a block number 2705 of the flash package address space, and a block number 2706 of the flash memory address space.

The flash package ID 2701 represents an ID of a corresponding flash package 113. The parity group ID 2702 represents a parity group 115 to which the corresponding flash package 113 belongs. The capacity 2703 represents an actual capacity of this corresponding flash package 113 (flash memory). The value of the capacity 2703 is not changed in accordance with expansion of the flash package address space.

The free capacity 2704 represents an actual capacity of a region in which data can be written. The free capacity represents a value which is obtained by subtracting the capacity of the region for storing data and the capacity of the garbage, from the value of the capacity 2703. The value of the free capacity 2704 increases by data erasure of the garbage.

The block number 2705 of the flash package address space is a number of an address space for managing the capacity of the flash package in the unit of blocks. The block number 2706 of the flash memory address space is a number of an address space for managing the capacity of the flash memory in the unit of blocks.

A block number 2706 of the flash memory address space is information representing a physical storage position of the flash memory, in association with the block number 2705 of the flash package address space. When data is stored first in a free block of the flash package address space, a block number of the flash memory address space for actually storing the corresponding data is assigned to the block number.

### (5) Striped Line Rebuilding

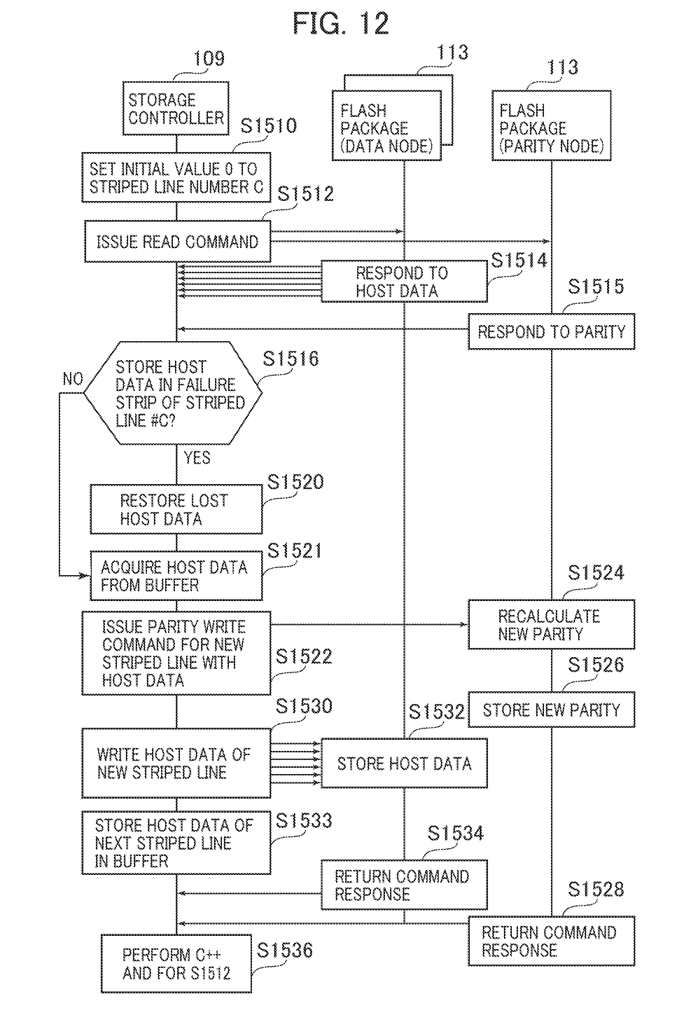

FIG. 12 illustrates an example of a process for rebuilding a striped line. FIG. 12 illustrates an example of a RAID type in which the number of parity strip is one. The storage controller 109 generates a parity group from the flash package 113. The internal circuit of each flash package 113 has a redundant configuration. The trouble in the flash package 113 is solved by the flash package 113. In occurrence of a trouble which cannot be solved by the flash package 113, the storage controller 109 solves it.

The storage controller 109 manages information of the flash package 113 constituting the parity group, and manages the striped line included in the parity group. Striped line rebuilding is controlled by the storage controller 109. Because the storage controller 109 manages the striped line rebuilding being executed, it uses a striped line number counter (striped line number C). The counter is configured, for example, inside the shared memory 111.

The striped line number C represents the number of old striped lines (striped line before rebuilding) as a target of a rebuilding process. In this embodiment, when the rebuilding for one striped line is completed, the storage controller 109 increments the striped line number C. The rebuilding is executed in ascending order of addresses in the address space (flash package address space) of the parity group.

First, the storage controller sets an initial value 0 to the striped line number C (S1510). The storage controller 109 selects strips constituting the stripe (old stripe) of the striped line number C, from the parity group. The striped lines are sequentially processed, to reduce the memory capacity necessary for the rebuilding. The storage controller 109 changes a value of the rebuilding state 2409 of the blocks of the selected stripe, to “rebuilding”. As will be described later, the number of strips of the new striped line is a predetermined number smaller than the number of strips before rebuilding.

The storage controller 109 issues a read command for reading host data and parity of the striped line (S1512). The normal flash package 113 in which host data is stored responds to the storage controller 109 with the host data (S1514). The flash package 113 in which parities are stored responds to the storage controller 109 with the parities (S1515).

The storage controller 109 determines whether host data is stored in a strip with a trouble (S1516). Because the parities of the striped line are regularly arranged, the number of a flash package storing the host data is calculated from the striped line number.

When the host data is stored (S1516: YES), the storage controller 109 restores lost data which has been stored in a trouble drive from the received host data and parity data (S1520).

When the stored data includes the parity (S1516: NO), the parity is recalculated in the striped line rebuilding, there is no need to restore the lost parity. The storage controller 109 proceeds to S1521.

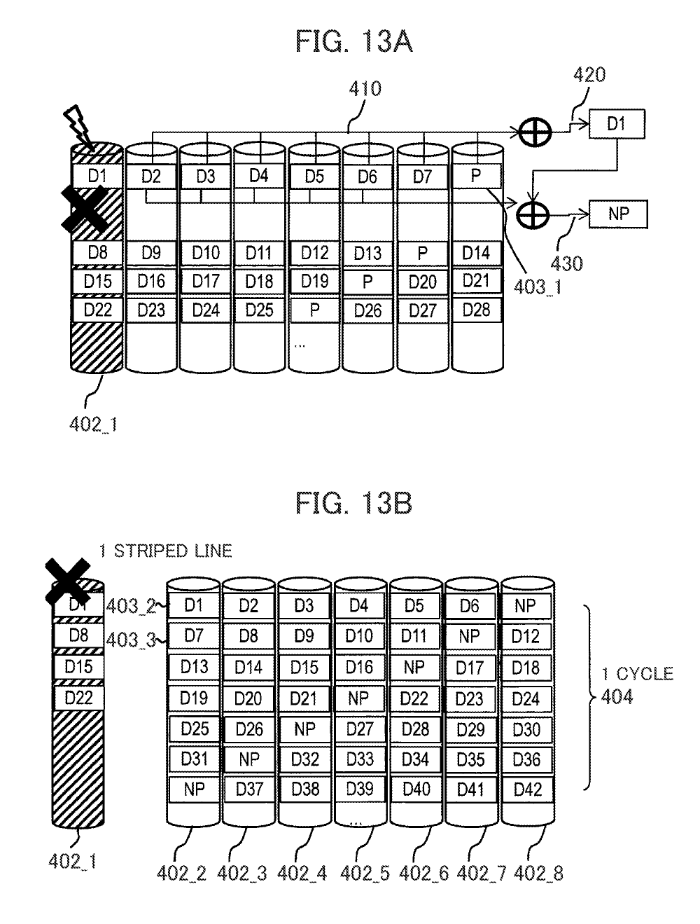

FIG. 13A and FIG. 13B illustrate a restoration example of host data. FIG. 13A and FIG. 13B illustrate an example of a trouble in the raid type of 7D+1P. FIG. 13A illustrates a state before rebuilding, while FIG. 13B illustrates a state after rebuilding. Eight flash packages 113 respectively having memory address spaces 402_1 to 402_8 in the flash package form a parity group.

In a striped line 403_1, host data Dn is stored in the memory address space 402_n. It is any of n=1 to 7. A parity P is stored in the memory address space 402_8. The parity P is generated from host data D1 to D8.

When a trouble occurs in the flash package 113 of the memory address space 402_1 in which host data D1 is stored, the storage controller 109 reads host data D2 to D7 and the parity P of the same striped line (410), and restores the host data D1 (420).

Back to FIG. 12, the storage controller 109 rebuilds the striped line. The storage controller 109 determines data of the host strip of a new striped line.

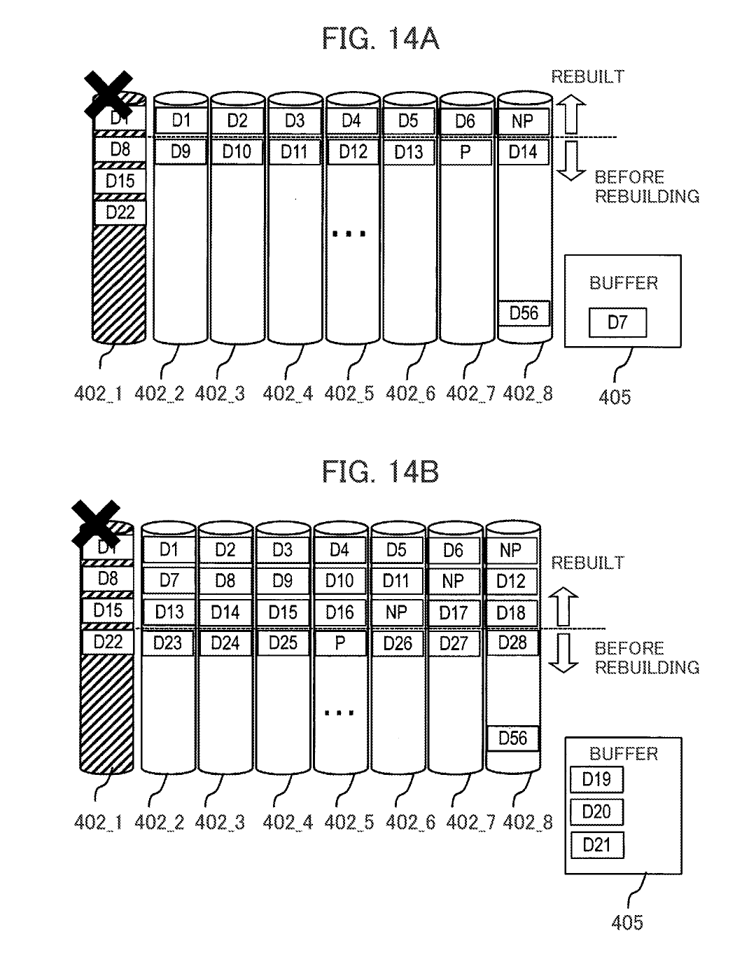

When host data of previous old striped line is stored in a buffer (a buffer 405 illustrated in FIGS. 14A and 14B), the host data and a part of host data of present old striped line are stored in a new striped line. When data is not stored in the buffer, only a part of the host data of the present old striped line is stored in the new striped line. The storage controller 109 can acquire the host data in the buffer, by reference to the flash package ID 2407 of the parity group information 2400.

The storage controller 109 recalculates the parity of the new striped line. The storage controller 109 writes the obtained parity in the flash package 113 storing the parity.

In one example, a parity write command is defined for the flash package 113. The storage controller 109 controls the flash package 113 in accordance with a parity write command to generate a new parity, and writes it in the flash package 113.

Specifically, the storage controller 109 issues a parity write command to the flash package 113 storing the parity of the new striped line, together with data for generating the parity (S1522).

The parity write command is to specify a range (address) in the flash package address space. The flash package 113 having received the parity write command performs XOR calculation for the received data, and calculates a new parity (S1524). In a specified address (address calculated therefrom in the flash memory space), the flash package 113 stores the new parity which has been calculated in the address (S1526). The flash package 113 having received a parity write command returns a response to the storage controller 109, in response to the parity write command (S1528).

The storage controller 109 issues a write command to the flash package 113 group storing host data of the striped line. The flash package 113 stores the host data (S1532), and returns a response to the storage controller 109, in response to the write command (S1534).

The storage controller 109 updates information of the parity group information 2400. Specifically, the storage controller 109 changes a value of “rebuilding” of any newly read data block to “rebuilt”, in the rebuilding state 2409.

Further, the storage controller 109 updates values of the flash package ID 2407 and the striped line number 2408, in association with a data block newly stored in the buffer or the flash package 113. In the flash package ID 2407 and the striped line number 2408, a value of the data block stored in the buffer represents a buffer address and a NULL value.

When all host data items for rebuilding a new striped line(s) are stored in the buffer, the storage controller 109 stores the corresponding host data and the new parity in the new striped line. Further, the storage controller 109 updates information of the parity group information 2400.

Finally, the storage controller 109 increments the striped line number C, and continues a process for the next striped line number (S1536). Note that the storage controller 109 may write the parity which has been calculated by the self-device into the flash package 113, in accordance with a write command.

In the configuration example of FIGS. 13A and 13B, the storage controller 109 changes the RAID type from 7D+1P to 6D+1P. A new parity NP is generated from the host data D1 to D6 and the parity P (430). To change the RAID type, the storage controller 109 stores again the host data and the parity in the flash package.

For a striped line 403_2, the storage controller 109 stores host data D1 to D6 in the memory address spaces 402_2 to 402_7, and stores a new parity NP in the memory space 402_8.

Next, the storage controller 109 creates the striped line 403_2 from host data D7 to D12 and the parity P. For the striped line 403_2, the storage controller 109 creates a new parity NP from the host data D7 to D12, and stores them respectively in the flash package address spaces.

One parity cycle 404 is formed with entire striped lines whose parity positions are different from each other. As illustrated in FIGS. 13A and 13B, the parity positions of the striped lines are regularly changed in accordance with the striped line numbers (addresses). That is, the striped lines are periodically arranged in accordance with the parity positions. In the parity group, the parity cycles (striped line group) with the same configuration are arranged.

For example, for the RAID type of 7D+1P, one parity cycle is formed with eight striped lines. For the RAID type of 6D+1P, one parity cycle is formed with seven striped lines. As will be described later, one page corresponds to an N (N is a natural number) number of parity cycles.

FIGS. 14A and 14B illustrate a data status in a parity group during rebuilding. During rebuilding, the parity group includes a new striped line after rebuilt together with an old striped line before rebuilding.

In FIG. 14A, the striped lines formed of host data D1 to D6 and the new parity NP have already been rebuilt. The striped lines from and after data D7 are before being rebuilt. Because the host data D7 stored in the memory address space 402_8 is overwritten, the storage controller 109 stores this data in the buffer 405, for evacuation before being overwritten. This results in eliminating reading of data from the parity group in the next rebuilding of stripes. The buffer 405 is configured, for example, in the shared memory 111.

As illustrated in FIG. 14B, when a striped line rebuilding process proceeds up to completion of host data D18, the buffer 405 stores host data D19 to D21. In the striped line rebuilding, when no host data is stored in the striped lines, that is, when “0” data is stored, data restoration is not necessary. In S1512, the storage controller 109 determines whether the parity of the striped lines is “0”. If the parity is “0”, it is determined that all data is “0”, and it can proceed to S1522.

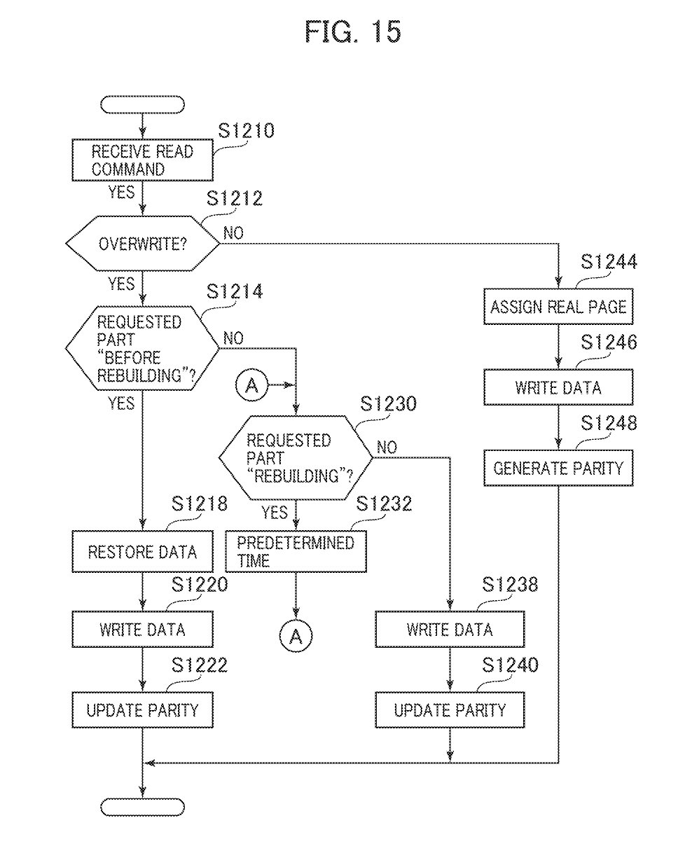

FIG. 15 illustrates a process when a write command is received, during rebuilding of the RAID. The storage controller 109 receives a write command from the host computer 101 (S1210). The storage controller 109 determines whether the received write command is for overwriting in an address in which a write command has been received beforehand (S1212).

When the write command is for overwriting (S1212: YES), the storage controller 109 proceeds to S1214. In any other case (S1212: NO), that is, in the case of writing for the first time, the storage controller 109 proceeds to S1244.

If a real page has not been assigned from the pool to a page in which write target object data is stored, the storage controller 109 assigns a real page from the pool (S1244), and the storage controller 109 writes data (S1246). It generates a parity in the parity group to which the real page is assigned (S1248).

In Step 1214, the storage controller 109 determines whether a write command target point is data in striped lines being rebuilt. Specifically, the storage controller 109 specifies a flash-side pool block number corresponding to a specified address of the write command, by reference to the virtual volume information 2000 and the page information 2500.

A state of rebuilding striped lines corresponding to the flash-side pool block number is represented in the parity group information 2400. Before rebuilding of the striped lines, specifically, before S1520, the storage controller 109 performs a write process for data (S1220), after restoration of lost data (S1218). If data is written before restoration, data other than the lost data is rewritten. As a result, it is not possible to restore the lost data.

After the write process, the storage controller 109 performs parity recalculation, and stores the parity (S1222). The parity recalculation is executed for a striped line (old striped line) before rebuilding of the striped line.

The storage controller 109 restores the lost data using the remaining host data and the parity. Next, the storage controller 109 overwrites new write data to data of a target point of the write command. The storage controller 109 generates a new parity from restored data, new write data, and remaining data.

For example, in FIG. 14A, the storage controller 109 restores the host data D8, overwrites write data (host data) D10′ to host data D10, and generates a new parity P′ from the host data D8, D9, D10′, D11, D12, D13, and D14.

When it is not before rebuilding of the striped line including a target region in the write command (S1214: NO), the storage controller 109 determines whether the striped line is being rebuilt (S1230). Specifically, the storage controller 109 determines whether the rebuilding state is “during rebuilding”.

When the striped line is being rebuilt (S1230: YES), the storage controller 109 waits for a preset period of time (S1232), and executes again determination of S1230. After data restoration, the stripes are rebuilt, and the value of the rebuilding state 2409 is changed to “rebuilt”.

When the target region of the write command is included in the striped line after rebuilt, specifically, when the rebuilding state 2409 represents “rebuilt” (S1230: NO), the storage controller 109 proceeds to S1238. The storage controller 109 writes data to the target region in the striped line after rebuilt (S1238), and updates the parity using the written result (S1240).

When the target region of the write command has already been rebuilt, and when the old data of the target region has been stored in the buffer, the storage controller 109 overwrites new data to the old data of the buffer. Updating of the parity is executed in the rebuilding of the striped lines including the target region.

In another example, when the striped line including the write target region is being rebuilt, an error is returned without receiving the write until the striped line is completely rebuilt, or information representing the rebuilding of the striped line may be returned with the error. In response to an error, the host waits for completion of rebuilding the striped line, to issue a write command again.

As described above, the storage controller 109 rebuilds the parity group (RAID configuration) with a small number of drives, thereby enabling to restore lost data which is lost due to a drive trouble, without using the spare drive. Redundancy of the RAID configuration after data restoration is made equal to redundancy of the RAID configuration before data restoration, thereby enabling to suppress the reduction in reliability after data restoration. The redundancy coincides with the number of strips which can be restored at the same time as in the striped line. The RAID level (for example, RAID 1, RAID 4, RAID 5, and RAID 6) after data restoration is made equal to the RAID level before data restoration, thereby enabling to suppress the reduction in reliability after data restoration.

For example, when a trouble has occurred in one storage device in the RAID configuration of 7D+1P, the storage controller 109 changes the RAID type to 6D+1P, to restore the lost data. Before/after restoration of the lost data, the redundancy and the RAID level can be maintained. The rebuilding in this embodiment is applicable to an arbitrary RAID type. It is applicable, for example, to a 3D+1P configuration (RAID 5), 7D+1P configuration (RAID 5), 2D+2D configuration (RAID 1), 4D+4D configuration (RAID 1), 6D+2P configuration (RAID 6), and 14D+2P configuration (RAID 6).

In one example, the storage controller 109 changes the RAID type in a manner that an integer number of parity cycles correspond to one page, before/after the rebuilding (rebuilding of striped line). As a result, before/after the rebuilding of the striped line, one page and the parity cycle are aligned, while the one cycle does not cross a page boundary. Then, it is possible to avoid an increase in the overhead depending on the access path or a decrease in performance at the occurrence of a trouble, as a result that one cycle crosses the page boundary.

For example, in the 7D+1P configuration, eight striped lines (56 host strips) form one parity cycle. In the 6D+1P configuration, seven striped lines (42 host strips) form one parity cycle. When one page is formed of, for example, 168 host strips, the boundary of the cycle coincides with that of the page, in both RAID types. 168 is the least common multiple of 56 and 42.

When one page is formed of 168 host strips, in both RAID types of the 3D+1P configuration and the 2D+1P configuration, the boundary of the cycle coincides with that of the page. In a normal state, the storage controller forms the parity group of the 7D+1P or 3D+1P in accordance with the user selection, and changes the configuration of the parity group to 6D+1P or 2D+1P, for a drive trouble.

Similarly, the storage controller 109 can change the 6D+2P configuration, for example, to the 4D+2P configuration, for a drive trouble, and can change the 14D+2P configuration, for example, to the 12D+2P configuration. One storage drive after change is used as a spare drive.

In one example, in the 6D+2P configuration, eight striped lines (48 host strips) form one parity cycle. In the 4D+2P configuration, six striped lines (24 host strips) form one parity cycle. When one page is formed of, for example, 48 host strips, the boundary of the cycle coincides with that of the page, in both RAID types.

Accordingly, by the change between the particular RAID types for the drive trouble and the particular page size, it is possible to maintain the page configuration controlled by the capacity virtualization function and to keep using the existing capacity virtualization function as is. The redundancy and/or the RAID level after the rebuilding of the striped lines may be changeable from that before rebuilding of the striped lines.

### (6) State Transition

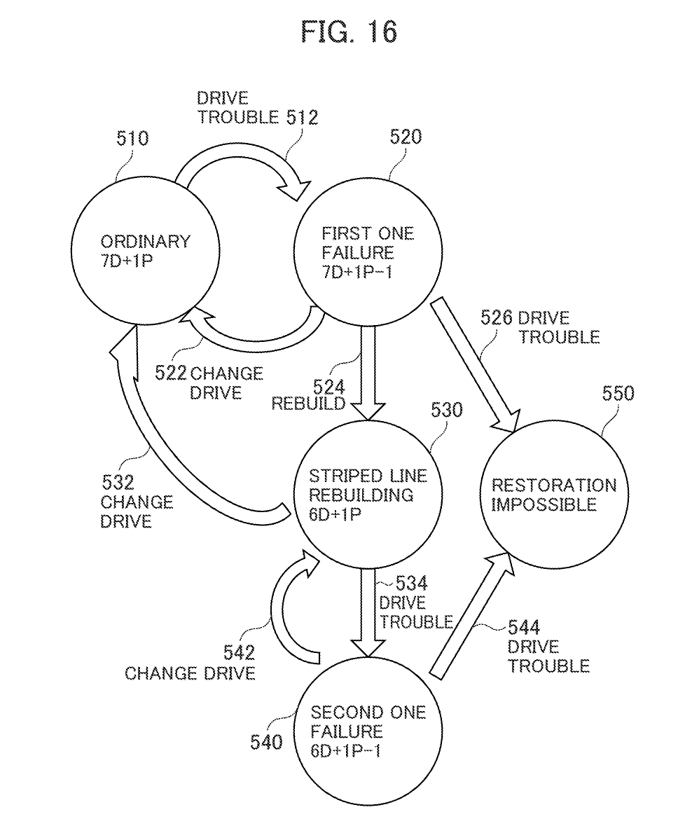

FIG. 16 illustrates a state transition in rebuilding of the striped line. FIG. 16 illustrates an example in which the RAID type in a normal operation is 7D+1P. A normal state 510 is a state in which a normal operation is performed in the 7D+1P. The storage device 104 transits from the normal state 510 to a first-one failure state 520, due to one drive failure (512). In the first-one failure state 520, the striped line (RAID configuration) is being rebuilt (in transition) from 7D+1P to 6D+1P.

After the striped line rebuilding (rebuild 524) is completed, the storage device 104 transits from the first-one failure state 520 to a striped-line rebuilding state 530. Further, the storage device 104 transits from the striped line rebuilding state 530 to a second-one failure state 540, due to one drive failure (534). The storage device 104 operates in this state, and waits for change of the drive (542). When there is further a drive trouble (544) from the second-one failure state 540, the storage device 104 transits to a state 550 in which data restoration is impossible.

When the drive is changed (532) in the striped line rebuilding state 530, the storage device 104 returns to the normal state 510. When the drive is changed (522) in the first-one failure state 520, the storage device 104 returns to the normal state 510. In the first-one failure (7D+1P−1) state 520, when a drive trouble (526) further occurs, the storage device 104 is in the state 550 in which data restoration is impossible.

In FIG. 16, let it be assumed that the striped line rebuilding state 530 is in a normal operation state. By adding one drive, the storage device 104 can transit to the state 510 of 7D+1P. That is, it is possible to add the storage drive one by one.

When the trouble drive is changed to a new drive, the storage device 104 returns to the configuration of the original RAID type. The storage device 104 rebuilds the striped line, and stores data again. This process is approximately the same as the process described by reference to FIG. 12, but does not include the data restoration process in the process of FIG. 12.

### (7) Free Capacity Management

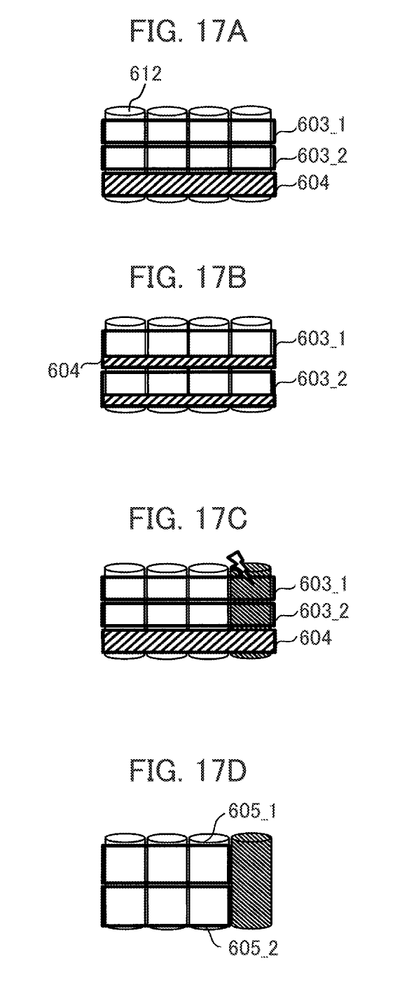

Because the storage device 104 does not have any spare drive, it manages the free capacity of the storage region, in order to maintain a free region necessary for rebuilding at the time of a drive trouble in the parity group. FIG. 17A to 17D illustrate an example of a free region in a parity group.

FIGS. 17A and 17B illustrate a state of the parity group before occurrence of a trouble. The parity group is formed of four storage drives 612. No spare drive is prepared. Volumes (or partitions) 603_1 and 603_2 are formed. In FIG. 17A, a free region 604 is secured in each volume. In FIG. 17B, a free volume is secured as the free region 604.

FIG. 17C illustrates that a trouble has occurred in one storage drive, in the configuration of FIG. 17B. FIG. 17D illustrates a state of a parity group after rebuilt. In three storage drives (new parity group) excluding the trouble drive, new volumes 605_1 and 605_2 are formed.

To eliminate the spare drive, it is necessary to always secure a free region for rebuilding. The capacity of the free region to be secured is in a preset ratio, for example, to an available capacity. This capacity is not a virtual capacity, but an actual capacity.

When the storage capacity 104 provides a virtual volume (TPVOL), the storage device 104 monitors the free capacity of the pool. The storage device 104 manages the capacity of the parity group, in order to maintain the free capacity necessary for the pool and the rebuilding.

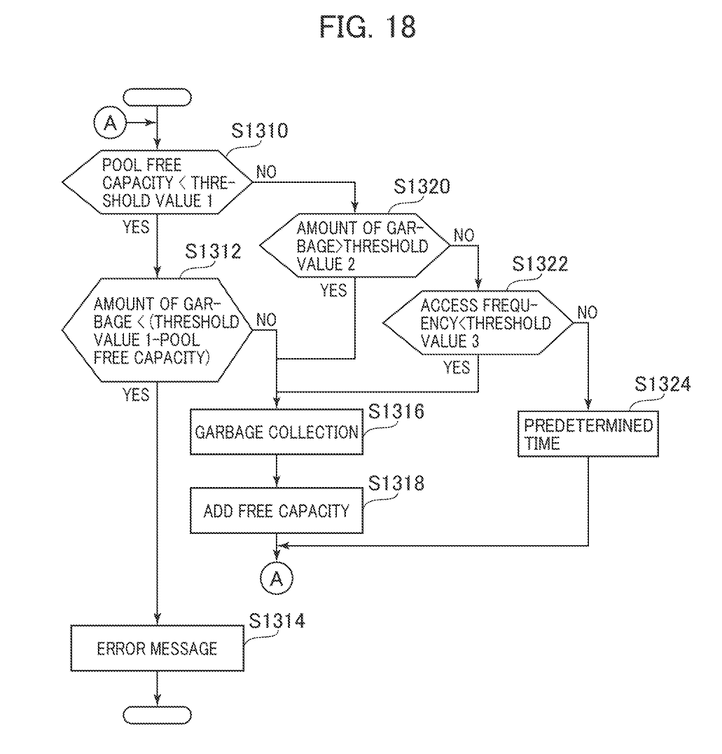

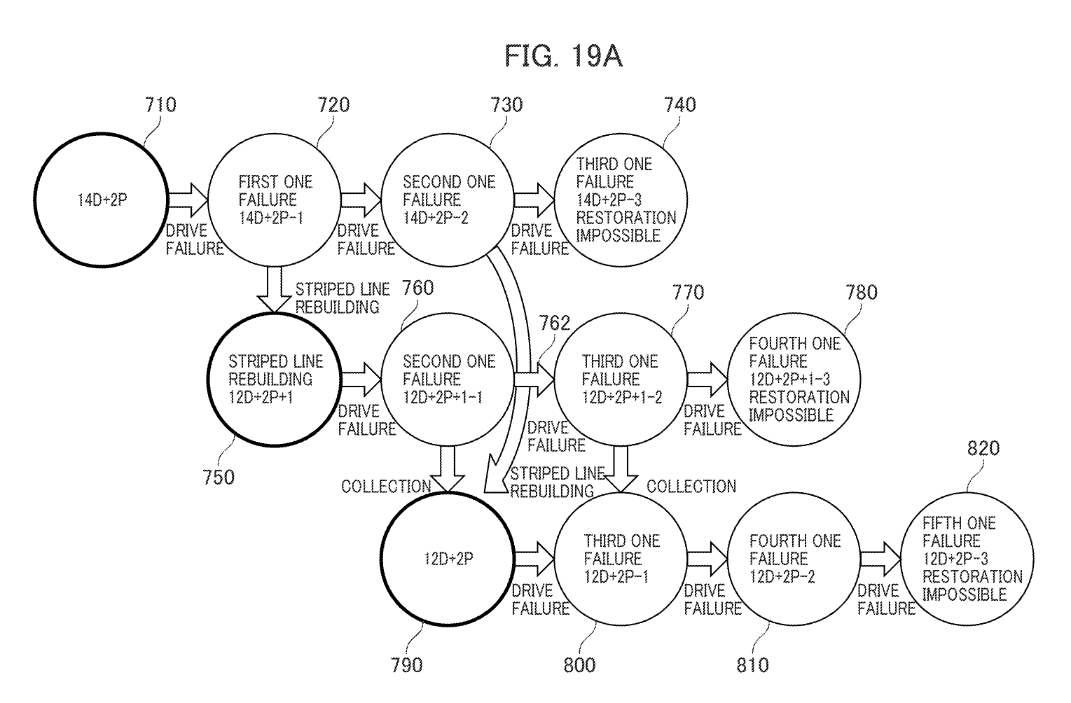

FIG. 18 illustrates a flowchart of a free capacity monitoring process. In this embodiment, the storage controller 109 executes the free capacity monitoring process. However, the management device 102 may manage the free capacity, instead of the storage controller 109.

The free capacity management process is executed, for example, at preset time intervals, or executed at the time of assigning a new real page to the virtual volume. When it is determined that the pool free capacity is not enough, the storage controller 109 secures a new free capacity.

The controller 109 determines whether the pool free capacity is lower than a threshold value 1 (S1310). The threshold value 1 is set in advance, and represents a total value of the minimum value of the free capacity necessary for the capacity virtualization function and the minimum value of the free capacity necessary for rebuilding. The controller 109 determines the pool free capacity, by reference to the free capacity 2304 of the pool information 2300 of the pool.

When the pool free capacity is lower than the threshold value (S1310: YES), the storage controller 109 determines whether the parity group includes garbage whose amount is insufficient for the threshold value 1 (S1312). The storage controller 109 refers to the amount of garbage 2405 of the parity group information 2400.

When there is no garbage having an amount in which the pool free capacity is insufficient for the threshold value 1 (S1312: YES), the storage controller 109 notifies the system manager and the user that the storage capacity itself is insufficient (S1314). The storage controller 109 outputs, for example, an error message to the management device 102.

When there exists garbage having an amount in which the pool free capacity is insufficient for the threshold value 1 (S1312: NO), the storage controller 109 performs a garbage collection process (S1316). Specifically, the storage controller 109 instructs the flash package 113 for garbage collection.

The flash package 113 executes an additional write process for newly writing data to the free region. Thus, the region with data previously written therein is accumulated as garbage in which data cannot be written. The flash package 113 executes an erasure process for converting the garbage into the free region, thereby adding the capacity which was garbage to the pool free capacity (S1318).

The storage controller 109 controls the garbage collection process, based on the amount of garbage and access frequency of the parity group. When the pool free capacity is sufficiently secured, and the amount of garbage is greater than a threshold value 2 (preset value) (S1320: YES), the storage controller 109 performs a garbage collection process (S1316).

When the amount of garbage is equal to or lower than the threshold value 2 (S1320: NO), and when the access frequency for the parity group is lower than a threshold value 3 (S1322: YES), the storage controller 109 performs a garbage collection process (S1316). The storage controller 109 manages the access frequency for the parity group, in non-illustrative management information. The storage controller waits for elapse of a predetermined time (S1324), and restarts this process.

S1320 and S1322 may be omitted. In this case, when the determination result of S1310 is “NO”, the process of this flowchart ends. The free capacity may be monitored by the management device 102. When it is determined that the free capacity is small, the management device 102 instructs the storage controller 109 for a process for securing the free region, or notifies that there is only small free region.

The flash package 113 may have a capacity virtualization function or compression function. The capacity of the flash package address space which is identified by the storage controller 109 is greater than the actual capacity in the flash package, that is, can be a virtual value. It is necessary to monitor the actual capacity in each flash package. In one method, the storage controller 109 acquires information of the actual capacity from the flash package 113. As a result of this, the physical capacity and the free capacity which are actually used can be managed.

The capacity (spare drive capacity) necessary for rebuilding needs to be secured since the beginning of the operation. At initial setting, the operator defines the virtual volume having the capacity virtualization function, based the capacity obtained by excluding the capacity for rebuilding from the actual mounting capacity.

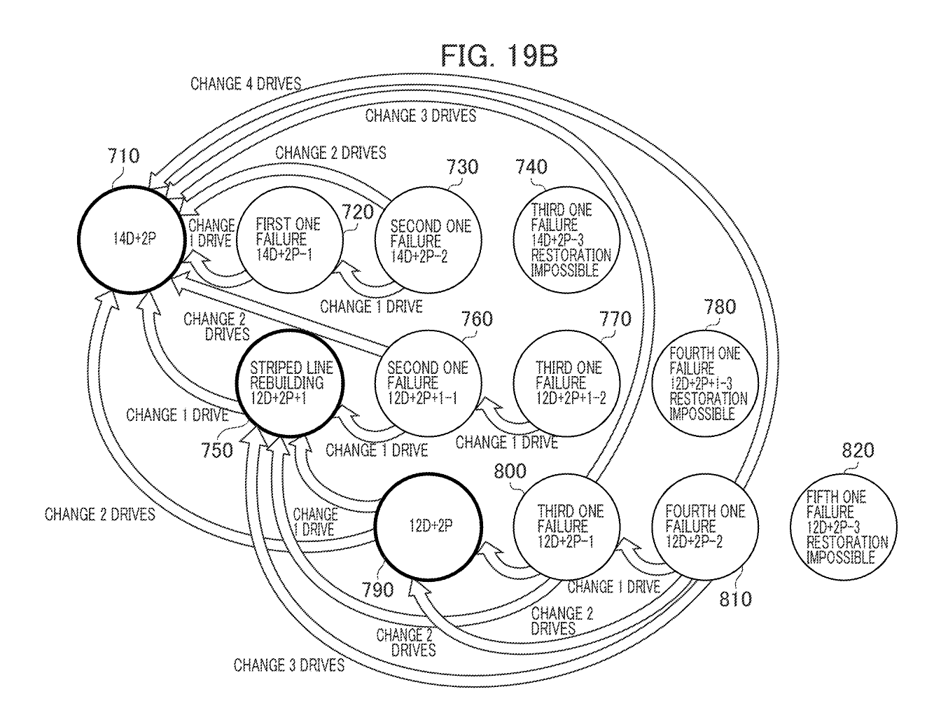

FIG. 19A and FIG. 19B illustrate an example of a state transition of the parity group having a 14D+2P (RAID 6) configuration. FIG. 19A illustrates a state transition due to a drive failure, while FIG. 19B illustrates a state transition due to changing of the drive. States 710, 750, and 790 have the required redundancy.

In FIG. 19A, the state 710 is an operation state in the 14D+2P configuration. When one storage drive has a failure, the storage device 104 transits into a state 720. Further, when the number of storage drives increases, the storage device 104 transits to states 730 and 740. In the state 740 where three storage drives have a failure, restoration (continue to operate) is impossible.

In the state 720 where one storage drive has a failure, the storage device 104 executes rebuilding of a striped line, and transits to the state 750. The parity group has a 12D+1P configuration. One storage drive is used as a spare drive.

In the state 750 in operation in the 12D+1P configuration, if one storage drive further has a failure, the storage device 104 transits to a state 760. Further, if the number of failures of the storage drive(s) increases, the storage device 104 transits to a states 770 and 780. In the state 780 where three (totally four) storage drives have a failure in the 12D+1P configuration, restoration (continue to operate) is impossible.

In operation in the 14D+2P configuration, in the state 730 where two storage drives have a failure, the storage device 104 executes rebuilding of the striped line, and transits to a state 790. The parity group has a 12D+1P configuration, and no spare drive is prepared.

In the state 790, if one more storage drive has a failure, the storage device 104 transits to a state 800. Further, the number of failures in the storage drive increases, the storage device 104 transits to states 810 and 820. In the state 820 where three (totally 5) storage drives have a failure in the 12D+1P configuration, restoration (continue to operate) is impossible.

In operation in the 12D+2P configuration, in the state 760 where one (totally two) storage drive has a failure, the storage device 104 restores (collection) lost data of the failure storage drive to the spare drive, and the storage device 104 transits to the state 790.

In operation in the 12D+2P configuration, in the state 770 where two (totally three) storage drives have a failure, the storage device 104 restores (collection) lost data of one storage drive to the spare drive, and the storage device 104 transits to the state 800.

Accordingly, before/after the rebuilding of the striped line, it is possible to cope with the same number of failures in the drive. FIG. 19B illustrates a state transition due to changing of the drive. A particular number of failed drives are changed to normal drives, in a state other than the states 740, 780, and 820 where restoration is impossible. As a result, the storage device 104 can transit to the states 710, 750, or 790 with the required redundancy.

The present invention is not limited to the above embodiment, and various modifications are included. For example, the above embodiment is to specifically describe the present invention for easy understanding, and is not necessarily to limit any of those including all of the described constitutions. Apart of the configuration of one embodiment may be replaced by the configuration of another embodiment, and the configuration of one embodiment may be added to the configuration of another embodiment. Apart of the configuration of each embodiment may be added to, excluded from, or replaced by another configuration.

A part or all of the above-described configuration, function, and process may be realized with the hardware, by designing it with, for example, the integrated circuit. Each of the above-described configuration or function may be realized with the software, by the processor analyzing the program for realizing the functions and executing, using the software. Information of the program, table, and file for realizing the functions may be put in a storage device, such as a memory, hard disk, SSD (Solid State Drive), or on a storage medium, such as an IC card or SD card. Control lines or information lines have been illustrated for the sake of descriptions. All of control lines or information lines are not necessarily illustrated, on the product. In fact, it can be regarded that nearly all configurations are mutually connected with each other.

1. A computer system comprising:
a memory; and
a processor which operates in accordance with a program stored in the memory,
wherein the processor
detects a failure of a storage drive in a first RAID group of a first RAID type,
in each of striped lines including lost host data due to a failure of the storage drive, restores the host data, in the first RAID group,
forms data of a striped line of a second RAID type from host data of a striped line in the first RAID group, number of strips of the second RAID type being smaller than number of strips of the first RAID type,
configures a second RAID group of the second RAID type by the storage drive included in the first RAID group excluding the failed storage drive, and
stores the data of the striped line of the second RAID type in the second RAID group.

2. The computer system according to claim 1,
wherein redundancy of the first RAID type and redundancy of the second RAID type are same.

3. The computer system according to claim 2,
wherein a RAID level of the first RAID type and a RAID level of the second RAID type are same.

4. The computer system according to claim 1,
wherein the processor assigns a storage region from the first RAID group and the second RAID group to a virtual volume, in unit of pages,
a boundary of the page coincides with a parity cycle boundary of the first RAID type and the second RAID type.

5. The computer system according to claim 1,
wherein the processor
reads data of a first striped line from striped lines in the first RAID group,
restores lost host data, when the data of the first striped line includes the lost data,
forms data of a second striped line of the second RAID type, when a part of host data of a striped line just before the first striped line is stored in a buffer, from the part of host data and a part of host data of the first striped line, and when the part of host data of the striped line just before the first striped line is not stored in the buffer, from the part of host data of the first striped line,
stores host data not used for forming data of the second striped line in the first striped line, in the buffer, and overwrites the data of the second striped line in a data storage region of the first RAID type.

6. The computer system according to claim 5,
wherein the processor
reads the first striped line, thereby executing a write command for the first striped line before storing data of the second striped line after storing data of the second striped line.

7. The computer system according to claim 1,
wherein the processor
assigns a storage region from a pool to a virtual volume in unit of pages,
manages mapping between a storage region of the first RAID group and the pool, and
controls garbage collection in the first RAID group,
based on a free capacity of the pool.

8. A method for restoring lost data of a failed storage drive, comprising:
detecting a trouble in a storage drive in a first RAID group of a first RAID type;
in each of striped lines including host data which is lost due to a failure of the storage drive, restoring the host data, in the first RAID group;
forming data of a striped line of a second RAID type from host data of a striped line of the first RAID group, number of strips of the second RAID type being smaller than number of strips of the first RAID type;
configuring a second RAID group of the second RAID type by a storage drive included in the first RAID group excluding the failed storage drive; and
storing data of a striped line of the second RAID type in the second RAID group.
